(19) United States
(12) Patent Application Publication
(10) Pub. No.: US 2007/0137928 A1
(43) Pub. Date: Jun. 21, 2007

(54) Multistory building fast escape and rescue device using a body that slides through a pressurized tube

(76) Inventor: Manuel Ivan Guillermety, Guaynabo, PR (US)

Correspondence Address: Manuel Ivan Guillermety, Urb. Extension Parkville, Mexico Street #C-4, Guaynabo, PR, 00969, US

(21) Appl. No.: 11/313,059

(22) Filed: Dec. 19, 2005

(51) Int. Cl. A62B 1/20

(52) U.S. Cl. 182/48

(57) ABSTRACT

An escape and rescue device used in a multistory building during a terrorist threat or a fire to: a) evacuate a person or persons attached to a plunger shaped body lowered from an upper level of a building through a vertical tube, by using two different pressures, a lesser pressure at the entrance of the tube and a higher pressure at the exit of the tube, using air tight compartments and doors at one or both sides of the tube or by artificial air pressure, thereby permitting the fast evacuation of many people in a short time, b) it can be used by fireman in training in its use and benefits, c) also at amusement parks, where there would be a ride that would teach the users about its reliability and safety, and d) to transport firemen in a fast way from the ground to the upper floors without interfering with the evacuation in process at the stairways of the building.

### CROSS-REFERENCE TO RELATED APLICATIONS

(not applicable).

### FEDERALLY SPONSORED RESEARCH

(not applicable).

### SEQUENCE LISTING OR PROGRAM

(not applicable)

### BACKGROUND OF THE INVENTION

1. Field of Invention

This invention is related to the evacuation from buildings that are three or more stories high in a fast continuous method where a harness and a body and a pressurized tube are used to rescue persons and to send firefighters upward to the rescue of persons if a terrorist treat or a fire is in effect.

2. Prior Art

After the 9-11 Twin Towers tragedy in New York and other catastrophes on buildings where human lives were lost, I set myself to find a way to innovate the very obsolete ways of dealing with a fire at buildings where many persons would be defenseless and could not escape.

It was necessary to find a better way of evacuating people from buildings on fire with better equipment than is actually available in the market. At the time of the incident at the World Trade Center it was also noticeable that the firefighters had an almost impossible task of getting to the upper levels because of the evacuees going down the stairways.

In the early years of firemen and fire trucks the best way to save a lady in distress was by lowering her using a ladder that the fire engine truck had when it arrived to the site, where the men had to sometimes risk there own lives to get these people down the ladder. Once the first lady was on the ground, the brave fireman would sometimes chock to death while trying to get back and climb the ladder for a second time to find a second lady, this time with a child that would not go down the ladder due to the panic. The fireman would have to wait until the child fainted to get him down while at the same time other evacuees were waiting for the firemen to arrive to the assigned window of the building on fire to be saved.

Many had to jump from high places and fall to a ring that had sometimes over 8 men holding the rescue device, abandoning more responsible tasks while in the rescue. The live saving process was slow. It ended in tragedies that added up costing many lives, and only a few would be alive to tell us about the story of the moments of terror that they lived. The rescue equipment and available firefighter systems have changed very slowly with the years, and every day there is more need for a solution to this condition.

Nowadays the evacuation problem in case of an emergency is broader, with more buildings being constructed, where taller structures and with even more people living in them, in many more cities than before. To this we have to add the unfortunate burden of having to deal with terrorist, arsonists, and mentally deviated lunatics that are constantly thinking of what, where and when to strike to cause damage. In opportunities, the situation has been so critical that the people entrapped by the fire or the smoke would finally decide to jump from the roof of the buildings to the ground because they would feel hopeless even knowing that with this action they would end their life, but also their agony.

I had the opportunity to search many Patents and Publications from the PTO related to escape devices that seamed interesting, some partially functional systems, but none were found that have the excellent use that my proposed patents have. A list is shown:

| Patents: | Publications: |
|---|---|
| 6,085,873 | 20050126857 |
| 5,718,627 | 20050098383 |
| 5,704,841 | 20040262083 |
| 5,593,374 | 20040182646 |
| 5,583,326 | 20040112674 |
| 5,447,211 | 20030205430 |
| 5,445,060 | 20030136608 |
| 5,407,029 | 20030106742 |
| 5,235,144 | 20030085073 |
| 4,997,060 | 20020125076 |
| 4,986,041 | 20020108812 |
| 4,948,303 | 20010023793 |
| 4,545,574 | |
| 4,521,130 | |
| 4,488,621 | |
| 4,487,410 | |
| 4,451,182 | |
| 4,350,224 | |

I also searched areas related to pneumatic tube escape and rescue systems or people escape systems using air pressurized methods and did not find any similarity with my escape and rescue device.

3. Objects and Advantages

These are some of the objects and advantages described in this escape and rescue device:
a) I was able to investigate and perform tests related to the fact that I can evacuate with a plunger shaped body through a tube, a lightweight boy and a grownup man at the same speed rate if I set the valve at the plunger shaped body at a different opening positions, making the evacuation process in a continuous way.
b) I was able to investigate and perform tests related to the fact that I can accelerate a person with the plunger shaped body through the tube, by means of holes and valves of different quantities, sizes and locations, which are placed from the inside to the outside of the barrel of the tube making the evacuation process faster and easier.
c) I was able to investigate and perform tests related to the fact that I can decelerate the person attached to the plunger shaped body at the end of the vertical travel from a high speed downward motion to a gradual stop, by means of holes and valves of different quantities, sizes and locations which are placed from the inside to the outside at the lower end of the tube, making the evacuation process faster and safer.
d) I was able to investigate and perform tests of the lifting system by using a dummy attached to the plunger shaped body which by pressurized air was accelerated upward and said lift speed was maintained due to a pattern of holes and valves of different quantities, sizes and locations, which are placed from the inside to the outside of the barrel of the tube, on the length of the tube, making the simulated rescue job faster and safer.
e) I investigated and performed tests with a dummy attached to the plunger shaped body which after inducing a lift upward with a constant air pressure, the dummy was brought to a complete safe stop at the selected position by means of a pattern of holes and valves of different quantities, sizes and locations, placed from the inside to the outside of the tube at the upper end of the tube, making initial travel in a short time and the slow down to a stop in a safe way making the rescue job faster and safer.
f) I also investigated both the acceleration process and the deceleration process at the same time, where in the downward travel of the persons being rescued, I initially inducing a high speed and then decelerated the person until he came to a total stop when he come to the exit floor level, through the use of a several sets of holes and valves on the tube placed from the inside to the outside which varied in location, sizes and amount of holes and valves.
g) I was also concerned with the fact that in some opportunities, rescue men and firemen when entering a building and trying to get to the upper floors would find it difficult due to the flow of evacuees running down the stairs. This mechanism of raising firefighters through a plunger shaped body using a pneumatic tube without interfering with the evacuees going down the stairways is the solution to many problems faced during a fire or terrorist treat on a building.
h) We recently learned that after the 911 Twin Tower incident in New York, the New York City Standards and Regulations Committee E06 on Performance on Buildings is now establishing new width on the stairs of new designed buildings to obtain more space for the firemen to go up while the evacuees are going down. If this escape and rescue device is used, this would be avoided.
i) The situation mentioned in the prior paragraph is a big issue since this could avoid the increase of the costs of construction of future buildings due to the more strict specifications which at the same time would be more expensive. This device may give way to the use of an engineering design waiver on the stairways to avoid these costs.

My testing and investigations related to the acceleration and deceleration of a person traveling attached to a plunger shaped body through a vertical tube has given me information that permitted me to create the fastest person evacuation method ever known.

The prototype that I build has given me the knowledge needed to safely speed up a plunger shaped person at a free fall initially and then when the vertical ride is coming to an end the plunger shaped body attached to the person would be slowed down carefully to a controlled stop.

This was done by means of a pattern of different quantities of holes and valves of different sizes and at different locations from the inside to the outside of the tube, along the length of the tube to increase the speed of the plunger shaped body, and afterwards at the end of the tube I placed a completely different pattern of holes or valves, of different quantities, sizes and at different locations, smaller in diameter to decrease the speed of the person until he was brought to a complete and safe stop at the landing level.

### SUMMARY

This device is to be used during a terrorist threat or a fire as a fast action fire escape and a rescue device to remove people from a multistory building. This mechanism is very user friendly, easy to use and has fast evacuation results. The invention consists of a plunger shaped body attached to a person that slides through a tube by using a higher pressure at the bottom of the plunger shaped body thus controlling the person's descend to safety. It not only helps the escapee to descend to safety, but it also is a way to send firefighters through the rescue device upward to the upper floors in a fast and safe way. Firefighters would be attached with a harness to the plunger shaped body to get through the tube up to the upper floors to help people that are trapped, unconscious or impaired and to help them get down through this or another escape device. The firefighters would not need to use the stairways which are used by the people evacuating the building, which interfere with the firemen trying to get to the upper floors.

### DESCRIPTION AND OPERATION

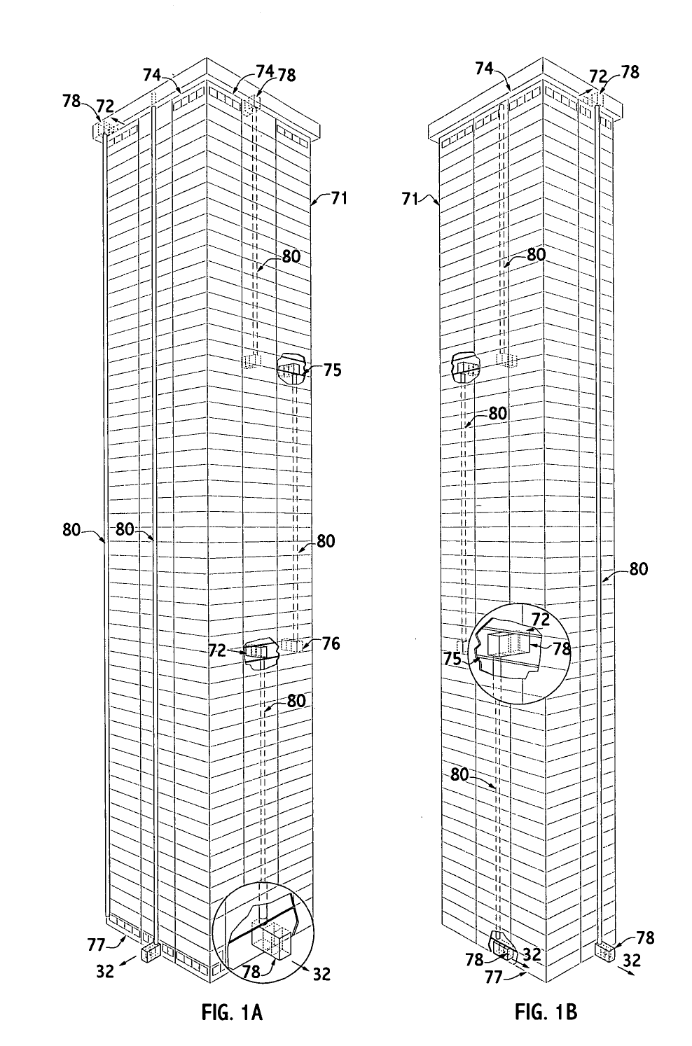

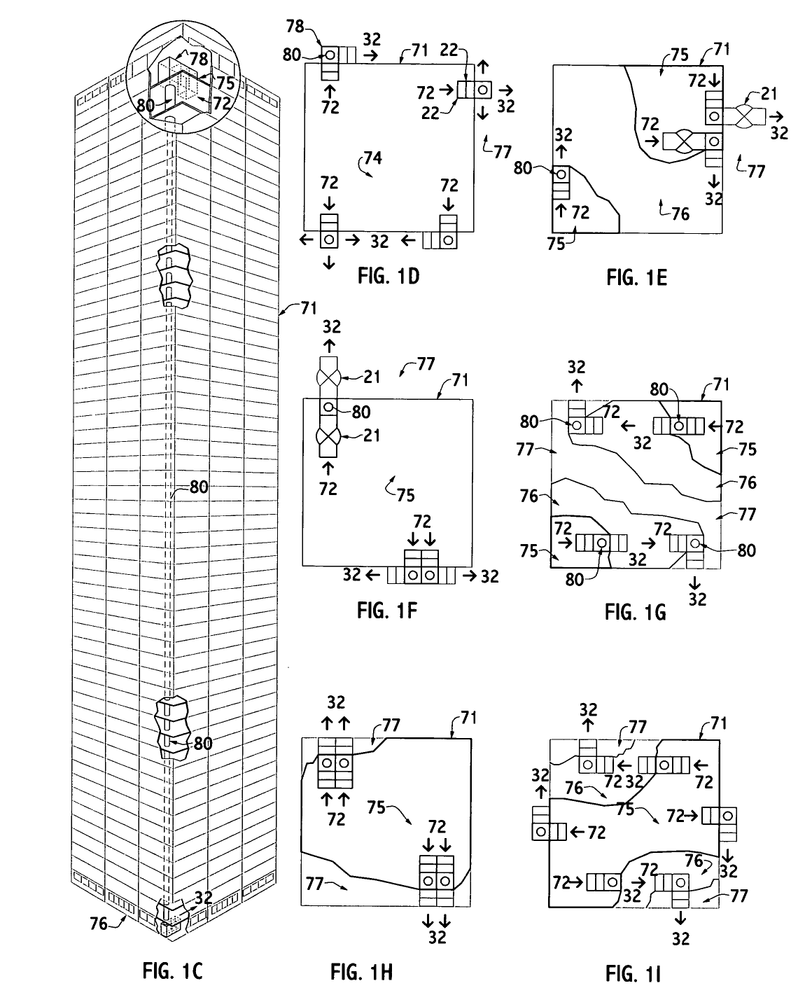

FIG. 1A, FIG. 1B and FIG. 1C

In an emergency due to terrorist threat or a fire on a building three (3) floors high to a one hundred and twenty (120) or more story high building or as is shown on FIG. 1A, FIG. 1B and FIG. 1C where a building 71 through an entrance 72 from a roof floor 74 or an upper floor 75 connected through a vertical tube 80 to a lower floor 76 or to ground floor 77 where an exit 32 is located creating a route of escape.

FIG. 1D, FIG. 1E, FIG. 1F, FIG. 1G, FIG. 1H and FIG. 1I:

FIG. 1D, FIG. 1E, FIG. 1F, FIG. 1G, FIG. 1H and FIG. 1I show different arrangements representing several floors in one plan, and a combinations of these arrangements where the escape device may be installed conducting from the entrance 72 from the roof floor 74 or the upper floor 75 through the vertical tube 80 that goes down to the lower floor 76 or to the ground floor 77 where the exit 32 is located.

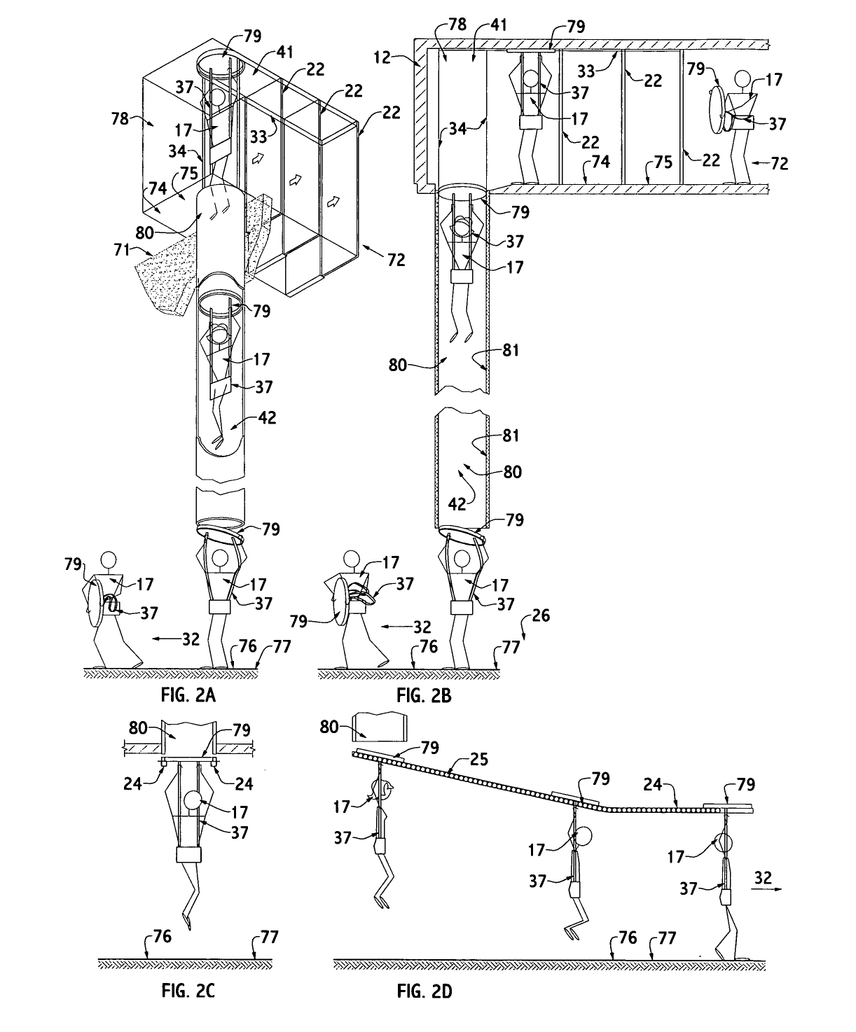

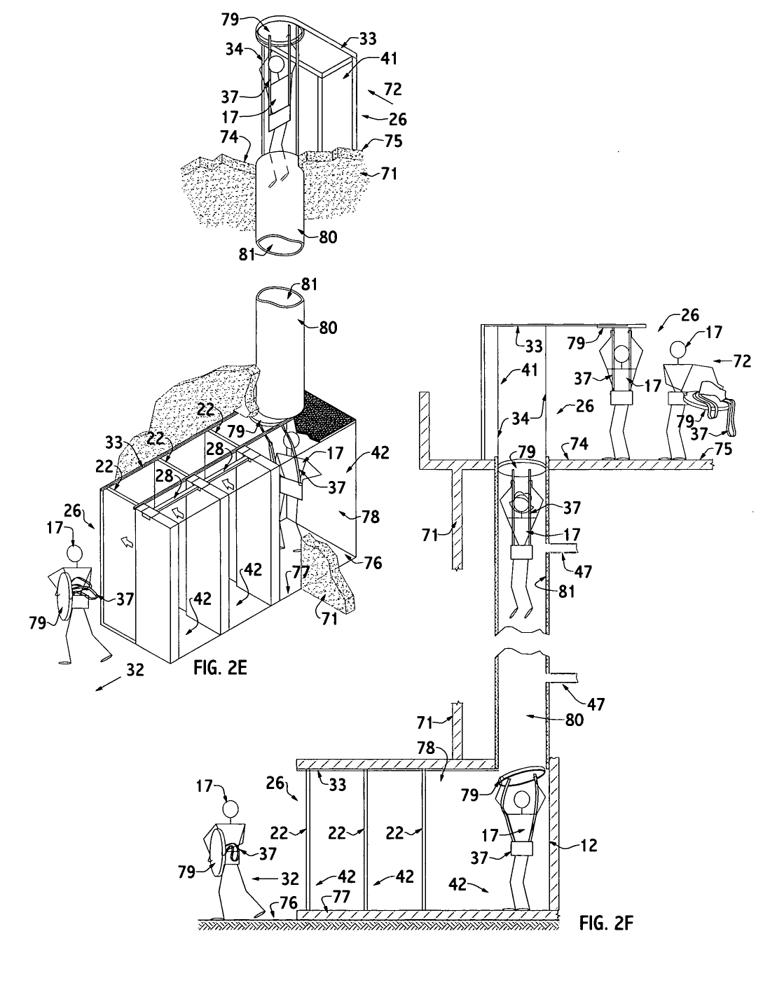

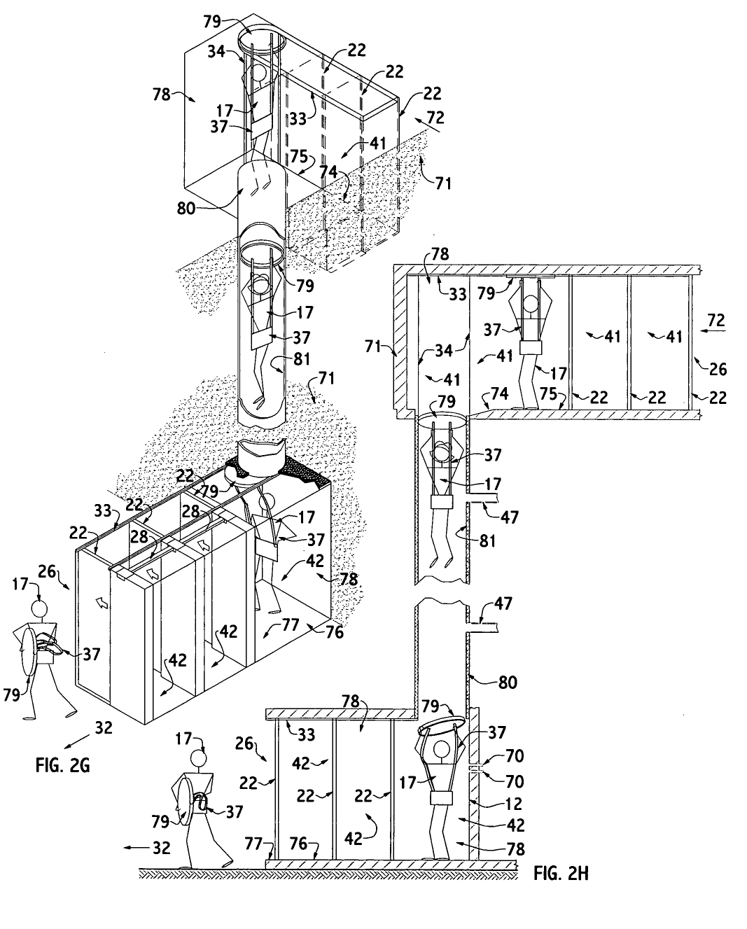

FIG. 2A and FIG. 2B

FIG. 2A and FIG. 2B show a version of the escape device that has a chamber 78 at the top only and through which a person 17 goes through the entrance 72 at the roof floor 74 or the upper floor 75 through a group of sliding doors 22 that controls the air pressure since only one sliding door 22 may be opened at a given time leading to the chamber 78 where when the person 17 attached through a harness 37 to a “plunger shaped body 79” descends through the vertical tube 80 creates a lesser pressure 41 above the “body 79” compared to a higher pressure 42 or an atmospheric pressure 26 existing below the “body 79” controlling the descent of the person 17 condition that will prevail until the person 17 reaches the lower floor 76 or the ground floor 77 where the exit 32 is located.

FIG. 2C and FIG. 2D

FIG. 2C and FIG. 2D show the “body 79” after leaving the tube 80 and where two lateral trays 24 and roller bearings 25 receive the weight of the “body 79” attached to the person 17 driving the “body 79” laterally to the lower floor 76 or to the ground floor 77 and then to the exit 32.

FIGS. 2E and 2F

FIGS. 2E and 2F show another version of the escape device being used where the person 17 goes through the entrance 72 from the roof floor 74 or the upper floor 75 where the person 17 attached to the harness 37 and to the “body 79” descend through the vertical tube 80 down to a chamber 78 creating a higher pressure 42 below the “body 79” which is higher than the atmospheric pressure 26 causing a controlled descend to the lower floor 76 or to the ground floor 77 and out to where the exit 32 is located. The lower chamber 78 keeps the higher pressure 42 through the sliding doors 22 since only one sliding door 22 may be opened at a given time. FIG. 2F also shows the ways to accelerate the “body 79” using the holes 47 where the location, size and amount of the holes 47 will determine the speed during the initial fall of the “body 79” and prior to the end of the fall at the lower section of the tube 80 by using other holes 47, smaller in size and quantity placed at the lower section of the tube 80, a reduction of the speed will take place until the “body 79” attached to the person 17 will stop at the assigned floor, being this the lower floor 76 or the ground floor 77.

FIG. 2G and FIG. 2H:

FIG. 2G and FIG. 2H show a version of the escape device, with two (2) chambers 78, one at the top and on at the bottom of the tube 80, and where the person 17 goes through the entrance 72 through the sliding doors 22 where only one sliding door 22 can be opened at a given time and into the upper chamber 78 located at the roof floor 74 or at the upper floor 75 where the person 17 attached to the harness 37 and to the “body 79” descends through the vertical tube 80 and where as shown in FIG. 2H while in the tube 80, the amount, size and location of the holes 47 cause an increase in the speed of the “body 79” sliding along the barrel of the tube 80 and before the “body 79” reaches the end of the tube 80 according to the location, size and amount of the small holes 70, there will be a reduction of speed of the “body 79” and the person 17 upon arriving to the selected exit floor will come to a stop at the lower chamber 78 where the higher pressure 42 is kept through the lower sliding doors 22 where only one sliding door 22 can be opened at a given time and where the person 17 walks through these sliding doors 22 toward exit 32.

FIG. 2I

FIG. 2I shows another version of the escape device where a plurality of the persons 17 walk to the entrance 72 through the sliding doors 22 that will keep the lesser pressure 41 in the upper chamber 78 at the top of the tube 80, the lesser pressure 41, and by using a controlled air flow 50 where each one of the persons 17 is attached to the harness 37 and where each harness 37 is attached to a “plunger shaped body 79” which when ready to be lowered, said “body 79” descends through the vertical tube 80 and while descending through the tube 80, the location, sizes and amount of the holes 47 will cause a rapid increase in the speed of the “body 79” and moments before the “body 79” reaches the end of the tube 80, according to the location, size and amount of the small holes 70, there will be a reduction of speed of the “body 79” when arriving to the lower chamber 78 located at the lower floor 76 or at the ground floor 77 where the higher pressure 42 located below the “body 79” will slowly decrease even though the higher pressure 42 is higher than the lesser pressure 41, where the higher pressure 42 is kept through the sliding doors 22 and the controlled air flow 50 and where the plurality of persons 17 after disengaging the harnesses 37 from the “body 79” may carry the “body 79” out through the exit 32, preparing the space for the descend of the next “body 79” and the plurality of persons 17 through the vertical tube 80.

FIG. 2J:

FIG. 2J shows a rescue device used to lift upward a firefighter 18 or a plurality of firefighters 18, which consists of one lower chamber 78 with a higher pressure 42 and an upper chamber 78 with a lesser pressure 41 and a tube 80 between them and by using a “plunger shaped body 79” that slides upward through the tube 80 according to the differential pressure between the lesser pressure 41 and a higher pressure 42 due to the pressure exerted by a blower 43, so when the firefighter 18 attached through the harness 37 to the “body 79” walks through the entrance 72 and the sliding doors 22 at the lower chamber 78, the firefighter 18 is ready to ascend through the vertical tube 80 at a high speed by using the pressure of the blower 43 and while in the tube 80 the holes 47 cause an increase in the upward speed obtaining a minimum time of travel until a moment before reaching the stopping point where according to the location, sizes and amount of the holes 70, the ascend of the “body 79” and the firefighter 18 will slow down arriving to the roof floor 74 or the higher floor 75 using a motorized lifting system 66 and an exit inclined railing toward the upper sliding doors 22 to the exit 32. This rescue device may be used to travel downward afterwards if necessary by decreasing the pressure of the blower 43 according to the weight of the persons 17 to be lowered.

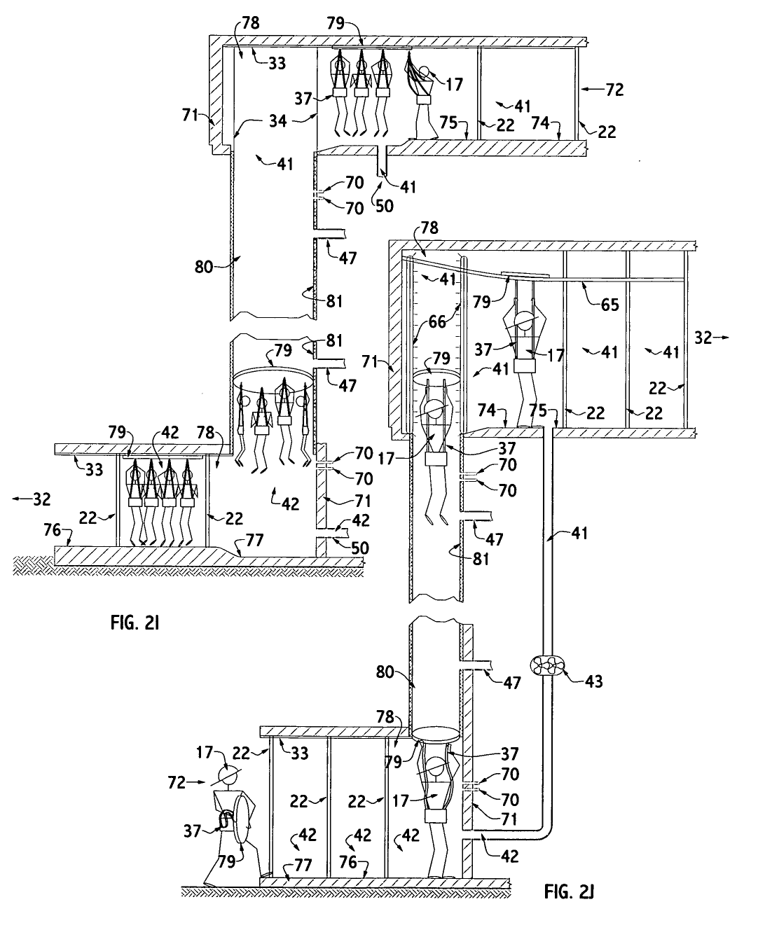

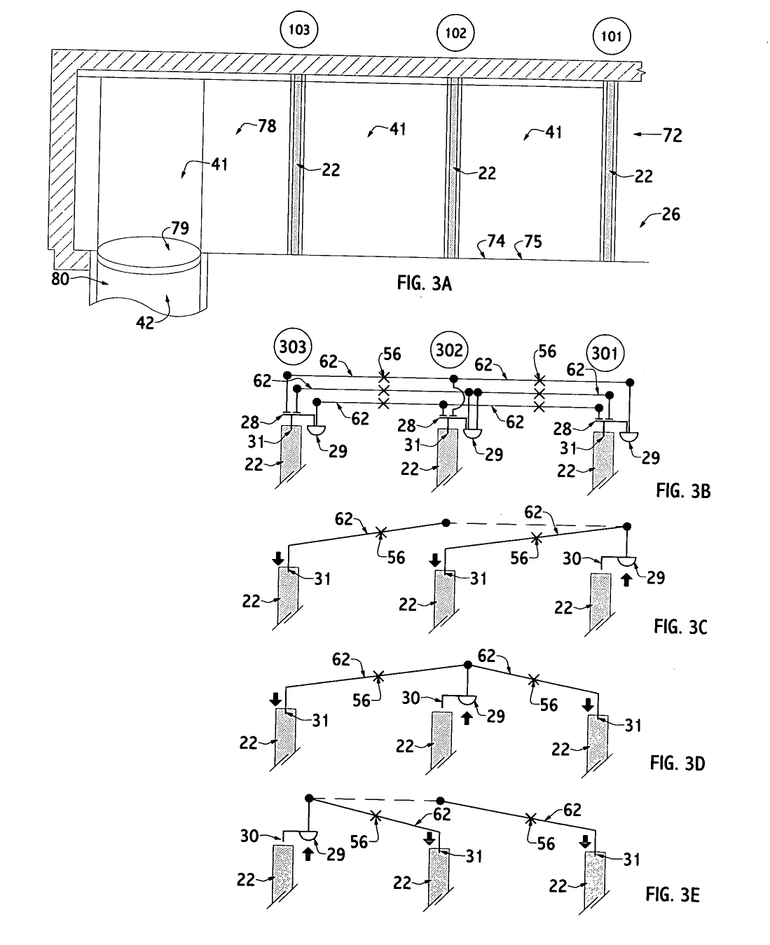

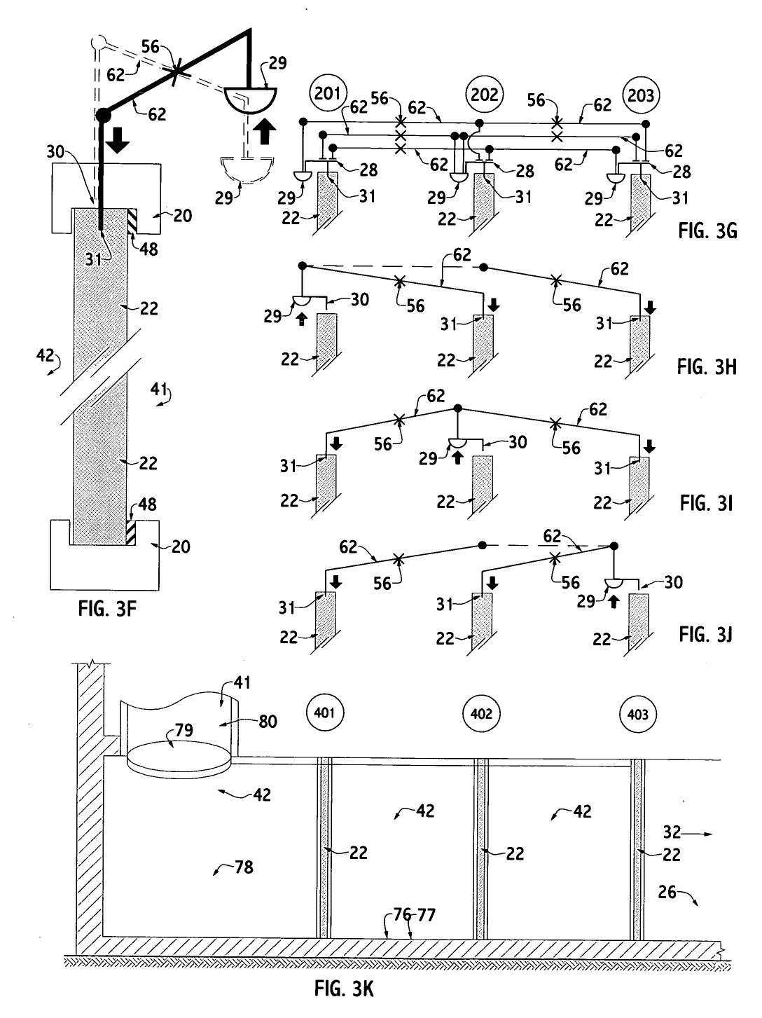

FIG. 3A:

FIG. 3A, shows the entrance 72 located at the roof floor 74 or at the upper floor 75 and a sequence of (3) three sliding doors 22 advancing from the right to the left that are connected to the chamber 78 and to the tube 80 as are presented in the prior FIG. 2A, FIG. 2B, FIG. 2G, FIG. 2H and FIG. 2I.

FIG. 3B:

FIG. 3B shows the three (3) sliding doors 22 advancing from the right to the left related to a locking system 28 where all the sliding doors 22 are in a lock position 31 and also it is shown that there is an interaction of these (3) sliding doors 22 through a push button 29 that does not permit that more than one of these sliding doors 22 is open at a given time where by using a hinge center 56 and a lever 62, the sliding doors 22 are in the lock position 31.

FIG. 3C:

FIG. 3C shows the three (3) sliding doors 22 advancing from the right to the left related to a locking system 28 that show that there is an interaction of these three (3) sliding doors where two (2) of the three (3) sliding doors 22 at locations marked 302 and 303 are in the lock position 31 while the sliding door 22 at location marked 301 is in a free position 30 and also it is shown that there is an interaction of the three (3) sliding doors 22 through the push button 29 that acts on the lever 62 using the hinge center 56 to lock both sliding doors 22 at locations marked 302 and 303 and at the same time releasing the sliding door 22 at location marked 301 to the free position 30 permitting that the sliding door 22 at location marked 301 be opened for access to the left side.

FIG. 3D:

FIG. 3D shows the three (3) sliding doors 22 advancing from the right to the left related to the locking system 28 that show that there is an interaction of these three (3) sliding doors where two (2) of the three (3) sliding doors 22 at locations marked 301 and 303 are in the lock position 31 while the sliding door 22 at location marked 302 is in the free position 30 and also it is shown that there is an interaction between the three (3) sliding doors 22 through the push button 29 that acts on the lever 62 using the hinge center 56 to lock both sliding doors 22 at locations marked 301 and 303 and at the same time releasing the sliding door 22 at location marked 302 to the free position 30 permitting that the sliding door 22 at location marked 302 be opened for access to the left side.

FIG. 3E:

FIG. 3E shows the (3) sliding doors 22 advancing from the right to the left related to the locking system 28 that show that there is an interaction of the three (3) sliding doors where two (2) of the three (3) sliding doors 22 at locations marked 301 and 302 are in the lock position 31 while the sliding door 22 at location marked 303 is in the free position 30 and also it is shown that there is an interaction of these (3) sliding doors 22 through the push button 29 that acts on the lever 62 using the hinge center 56 to lock both sliding doors 22 at locations marked 301 and 302 and at the same time releasing the sliding door 22 at location marked 303 to the free position 30 permitting that the sliding door 22 at location marked 303 be opened for access to the left side.

FIG. 3F:

FIG. 3F shows a detailed view of the sliding door 22 which separates the lesser pressure 41 and the higher pressure 42 using a seal 48 mounted on the sliding door 22 that is placed on a door frame 20 where the sliding door 22 is at the lock position 31 until the push button 29 is placed in the free position 30 by means of the lever 62 and the hinge center 56 permitting that the sliding door 22 be opened for access to the other side.

FIG. 3G:

FIG. 3G shows the (3) sliding doors 22 advancing from the left to the right related to a locking system 28 where all the sliding doors 22 are in a lock position 31 and also it is shown that there is an interaction of these (3) sliding doors 22 through a push button 29 that does not permit that more than one of these sliding doors 22 is open at a given time where by using a hinge center 56 and a lever 62, the sliding doors 22 are all in the lock position 31.

FIG. 3H:

FIG. 3H shows the (3) sliding doors 22 advancing from the left to the right related to a locking system 28 that show that there is an interaction of these three (3) sliding doors where two (2) of the three (3) sliding doors 22 at locations marked 202 and 203 are in the lock position 31 while the sliding door 22 at location marked 201 is in a free position 30 and also it is shown that there is an interaction of these (3) sliding doors 22 through the push button 29 that acts on the lever 62 using the hinge center 56 to lock both sliding doors 22 at locations marked 202 and 203 and at the same time releasing the sliding door 22 at location marked 201 to the free position 30 permitting that the sliding door 22 at location marked 201 be opened for access to the right side.

FIG. 3I:

FIG. 3I shows the three (3) sliding doors 22 advancing from the left to the right related to the locking system 28 that show that there is an interaction of these three (3) sliding doors where two (2) of the three (3) sliding doors 22 at locations marked 201 and 203 are in the lock position 31 while the sliding door 22 at location marked 202 is in the free position 30 and also it is shown that there is an interaction of these (3) sliding doors 22 through the push button 29 that acts on the lever 62 using the hinge center 56 to lock both sliding doors 22 at locations marked 201 and 203 and at the same time releasing the sliding door 22 at location marked 202 to the free position 30 permitting that the sliding door 22 at location marked 202 be opened for access to the right side.

FIG. 3J:

FIG. 3J shows the (3) sliding doors 22 advancing from the left to the right related to the locking system 28 that show that there is an interaction of these three (3) sliding doors where two (2) of the three (3) sliding doors 22 at locations marked 201 and 202 are in the lock position 31 while the sliding door 22 at location marked 203 is in the free position 30 and also it is shown that there is an interaction of these (3) sliding doors 22 through the push button 29 that acts on the lever 62 using the hinge center 56 to lock both sliding doors 22 at locations marked 201 and 202 and at the same time releasing the sliding door 22 at location marked 203 to the free position 30 permitting that the sliding door 22 at location marked 203 be opened for access to the exit side.

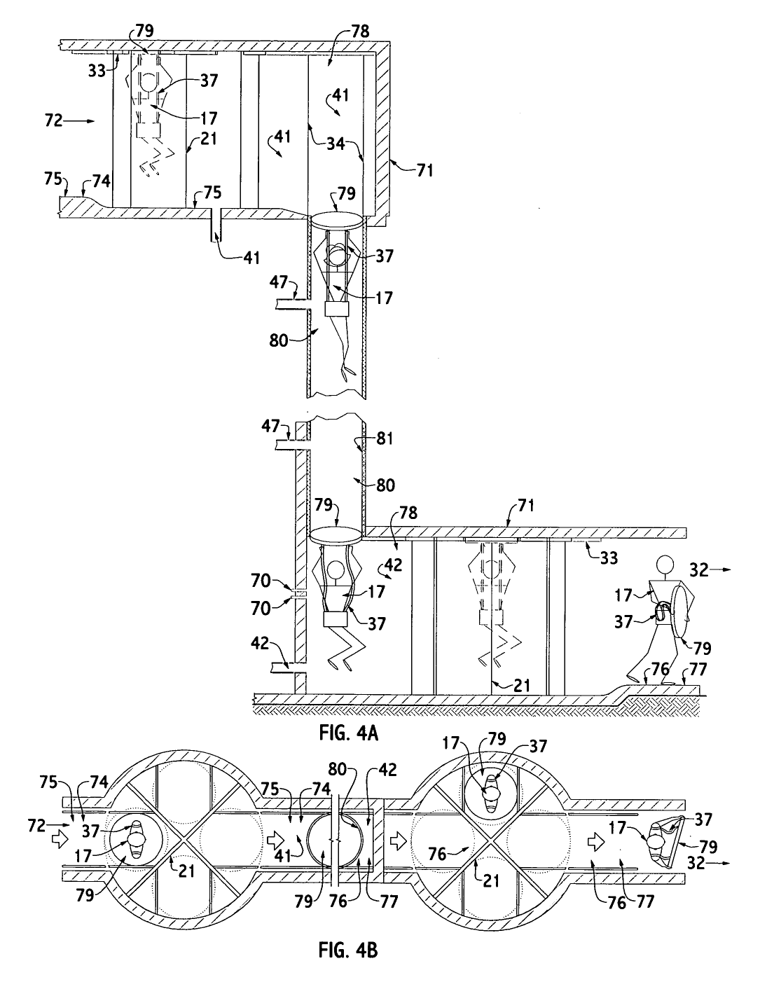

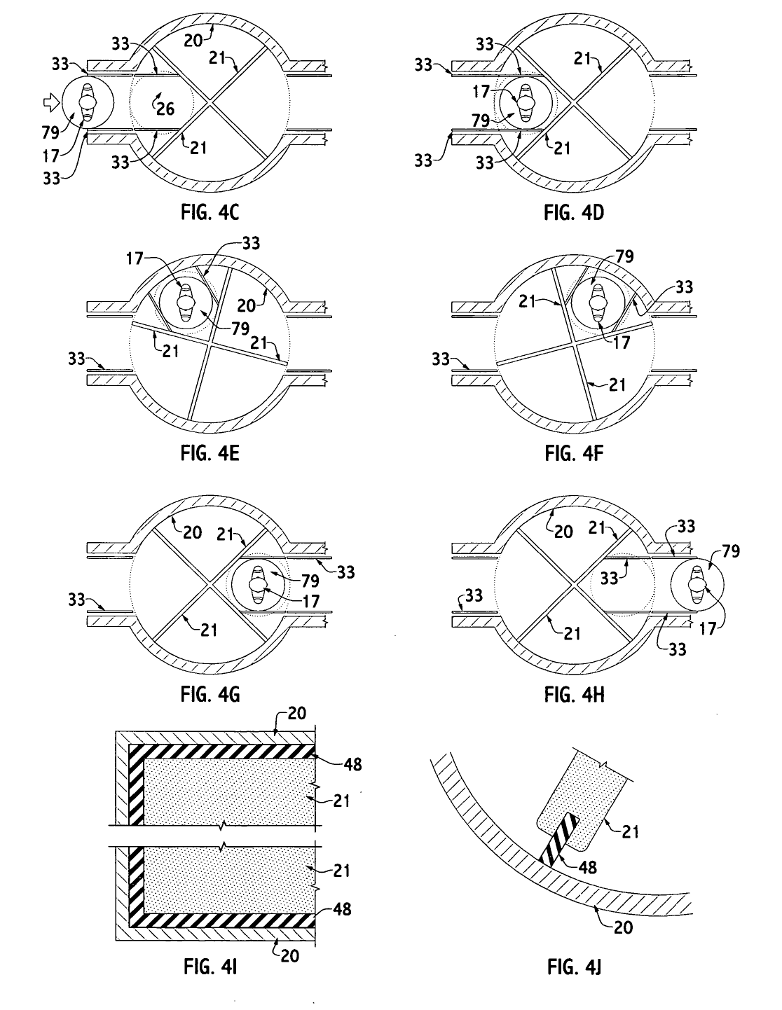

FIG. 4A:

FIG. 4A shows a lateral view of another version of the escape device, this time with (2) two revolving doors 21, used to control the differential pressure between the entrance and the exit of each revolving door 21, where one (1) revolving door 21 is used at the top and one (1) revolving door 21 is used at the bottom of the tube 80, and where the person 17 goes through the entrance 72 through the revolving door 21 and into the upper chamber 78 located at the roof floor 74 or at the upper floor 75 where the person 17 attached through the harness 37 to the “plunger shaped body 79” descend through the vertical tube 80 down to a lower chamber 78 located at the lower floor 76 or ground floor 77 creating a higher pressure 42 below the “body 79” which is higher than the lesser pressure 41 located at the upper side of the “body 79” and the holes 47 cause a decrease in the higher pressure 42 increasing in the speed of the “body 79” that slides along the barrel of the tube 80 and before the “body 79” reaches the end of the tube 80 according to the location, size and amount of the small holes 70, there is a reduction of speed of the “body 79” and the person 17 comes to a complete stop at the lower floor 76 or at the ground floor 77 at the lower chamber 78 where the person 17 leaves the revolving door 21 and goes through the exit 32.

FIG. 4B:

FIG. 4B shows a top view of the escape device shown in FIG. 4A which includes (2) two revolving doors 21, one (1) at the top and one (1) at the bottom of the tube 80, and where the person 17 attached to the “body 79” goes through the entrance 72 through the revolving door 21 located at the roof floor 74 or at the upper floor 75 descending through the vertical tube 80 creating a higher pressure 42 below the “body 79” which is higher than the lesser pressure 41 located at the upper side of the “body 79” causing a controlled descend to the lower floor 76 or to the ground floor 77 where the bottom revolving door 21 keeps the higher pressure 42 while the person 17 leaves the escape device through the exit 32.

FIG. 4C, FIG. 4D, FIG. 4E, FIG. 4F, FIG. 4G and FIG. 4H:

FIG. 4C, FIG. 4D, FIG. 4E, FIG. 4F, FIG. 4G and FIG. 4H show a top view of the sequence of movements of the person 17 attached to the “body 79” through each revolving door 21 either the revolving door 21 located at the entrance 72 (see FIG. 4B) at the roof floor 74 or at the upper floor 75, or the revolving door 21 located at the exit 32 (see FIG. 4B) at the lower floor 76 or ground floor 77 where in each case the “body 79” is placed on a rail 33 that keeps the person 17 elevated from the floor all times until he leaves the last revolving door 21.

FIG. 4I:

FIG. 4I shows a side view of a seal 48 attached to the top, side and bottom of the revolving door 21 that revolves against the frame 20 of the revolving door 21.

FIG. 4J:

FIG. 4J shows a top view of the seal 48 attached to the side of the revolving door 21 that revolves against the frame 20 of said revolving door 21.

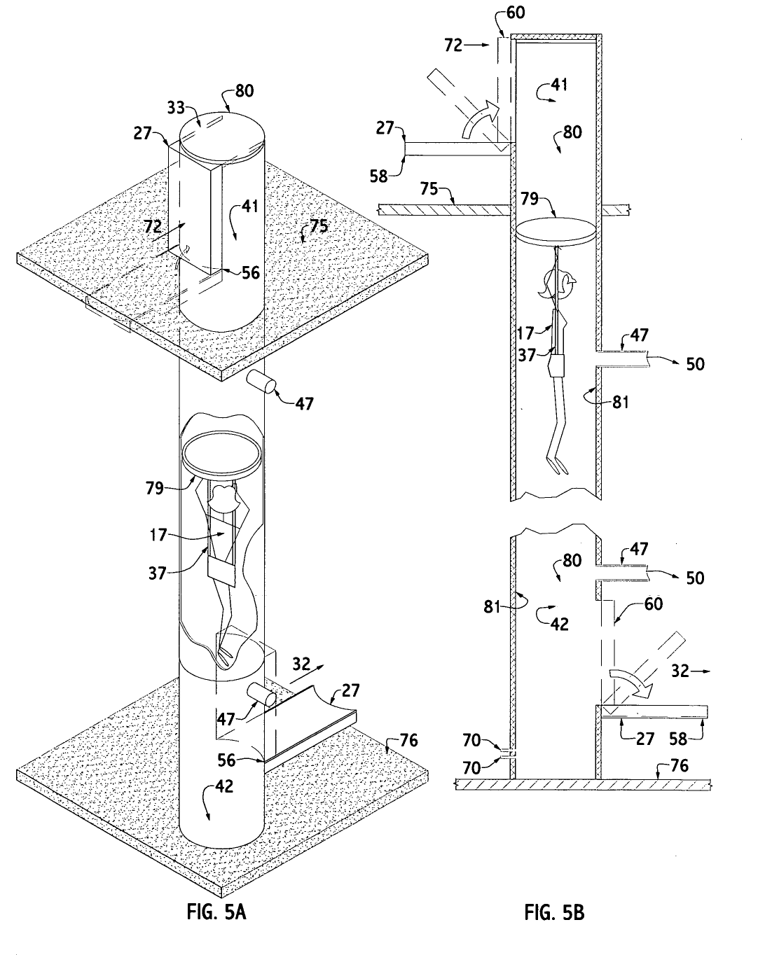

FIG. 5A and FIG. 5B:

FIG. 5A and FIG. 5B show another version of the escape device this time with (2) two hatch doors 27 one (1) at the top of the tube 80 and one (1) at the bottom of the tube 80, and where the person 17 attached to the “plunger shaped body” goes through the entrance 72 when the top hatch door 27 is open 58 and where the railings 33 will not release the body 79 until the top hatch door 27 is closed 60 being the top hatch door 27 at the top of the tube 80 and located at the roof floor 74 where the person 17 attached to the harness 37 and to the body 79 descend through the vertical tube 80 creating a higher pressure 42 below the “body 79” which is higher than the lesser pressure 41 located at the upper side of the “body 79” causing a controlled descend and where the holes 47 will increase the speed of the “body 79” attached to the person 17 and before the end of the tube 80 there is a deceleration controlled by the small holes 70 located at the bottom end of the tube 80 that will bring the “body 79” to a complete stop when it gets to the lower latch 27 at the ground floor 77 where once stopped the person 17 will open 58 the lower hatch 27 which is normally closed 60 and when opened 58 the person 17 leaves the escape device through exit 32.

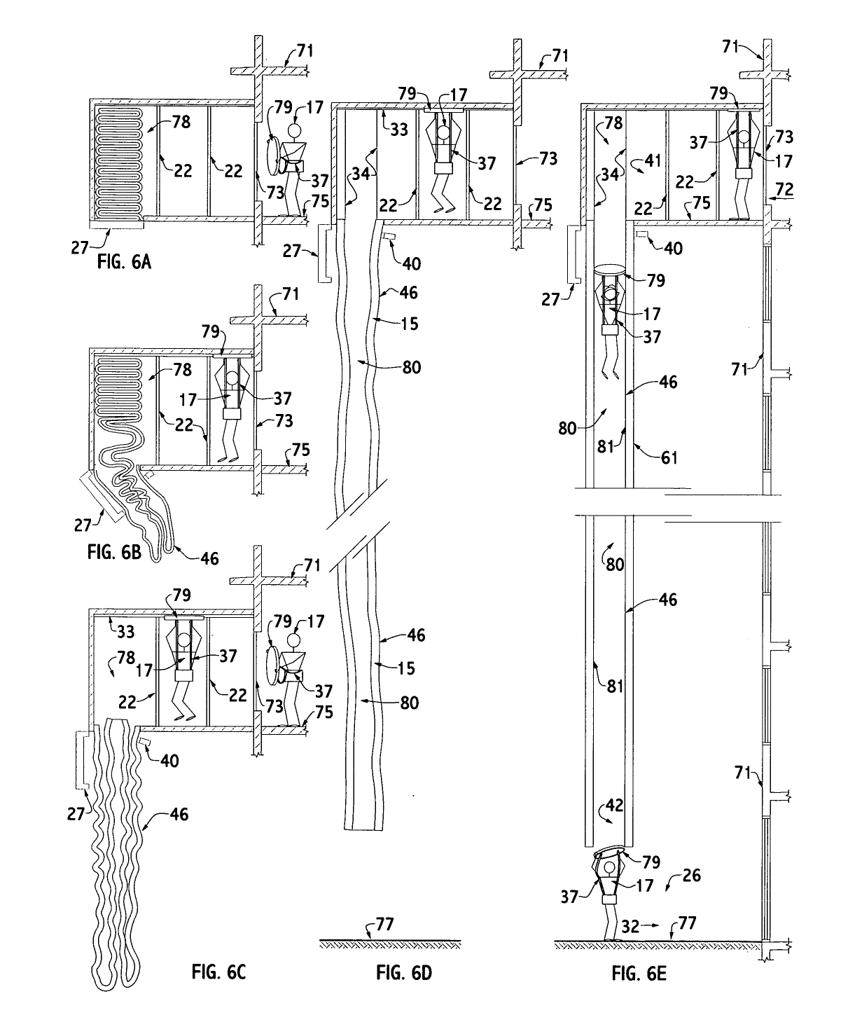

FIG. 6A:

FIG. 6A shows a version of the escape device in the form of an exterior chamber 78 attached to the building 71 and the sliding doors 22 placed at the roof floor 74 or upper floor 75 where in case of an emergency a person 17 attached thropugh a harness 37 to a “Plunger shaped body 79” may open the sliding doors 22 that have a control system that will let only one sliding door 22 open at the same time and then the person 17 gets into the chamber 78.

FIG. 6B:

FIG. 6B shows the chamber 78 and the sliding doors 22 attached to the building 71 placed at the roof floor 74 or upper floor 75 where in case of an emergency the person 17 attached to a harness 37 attached to the “body 79” opens the sliding doors 22 that will let only one sliding door 22 open and at the same time this person 17 gets to the chamber 78 where this person 17 opens a hatch 27 which deploys a double wall duct 46.

FIG. 6C:

FIG. 6C shows the chamber 78 and the sliding doors 22 attached to the building 71 placed at the roof floor 74 or upper floor 75 where the second person 17 attached to a harness 37 attached to the “body 79” opens the sliding doors 22 and at the same time the first person 17 gets to the chamber 78 where the person 17 that opened the hatch 27 gets the double wall duct 46 deployed which will be inflated with an air 40.

FIG. 6D:

FIG. 6D shows the chamber 78 and the sliding doors 22 attached to the building 71 placed at the roof floor 74 or upper floor 75 where in case of an emergency the person 17 attached to a harness 37 attached to the “body 79” gets to the sliding doors 22 that will let only one sliding door 22 open a the same time until the person 17 gets to the chamber 78 where the person 17 that opened the hatch 27 deploying the double wall duct 46 that is inflated with the air 40 giving form to the tube 80 which extends vertically from the window 73 from where it was deployed down to a height of approximately seven (7) feet above the ground below.

FIG. 6E:

FIG. 6E shows the chamber 78 and the sliding doors 22 attached to the building 71 placed at the roof floor 74 or upper floor 75 where in case of an emergency the person 17 attached to the harness 37 attached to the “body 79” opens the sliding doors 22 and enters and at the same time the person 17 that already is in the chamber 78 when lowered through the now inflated double wall duct 46 giving form to the tube 80 which when the “body 79” is lowered creates a difference in pressure between the lesser pressure 41 at the top of the “body 79” and the higher pressure 42 below the “body 79” and does so at a controlled speed through the tube 80 which extends from the window it was deployed to a height of approximately seven (7) feet above the ground, finally leaving the escape device through exit 32.

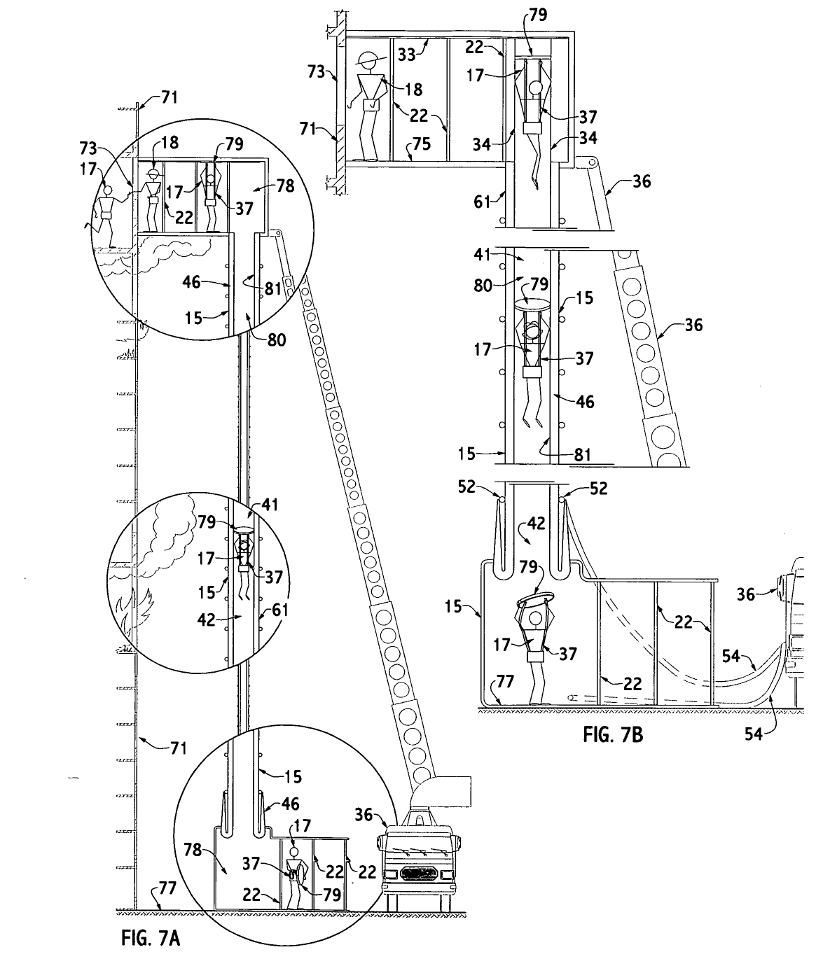

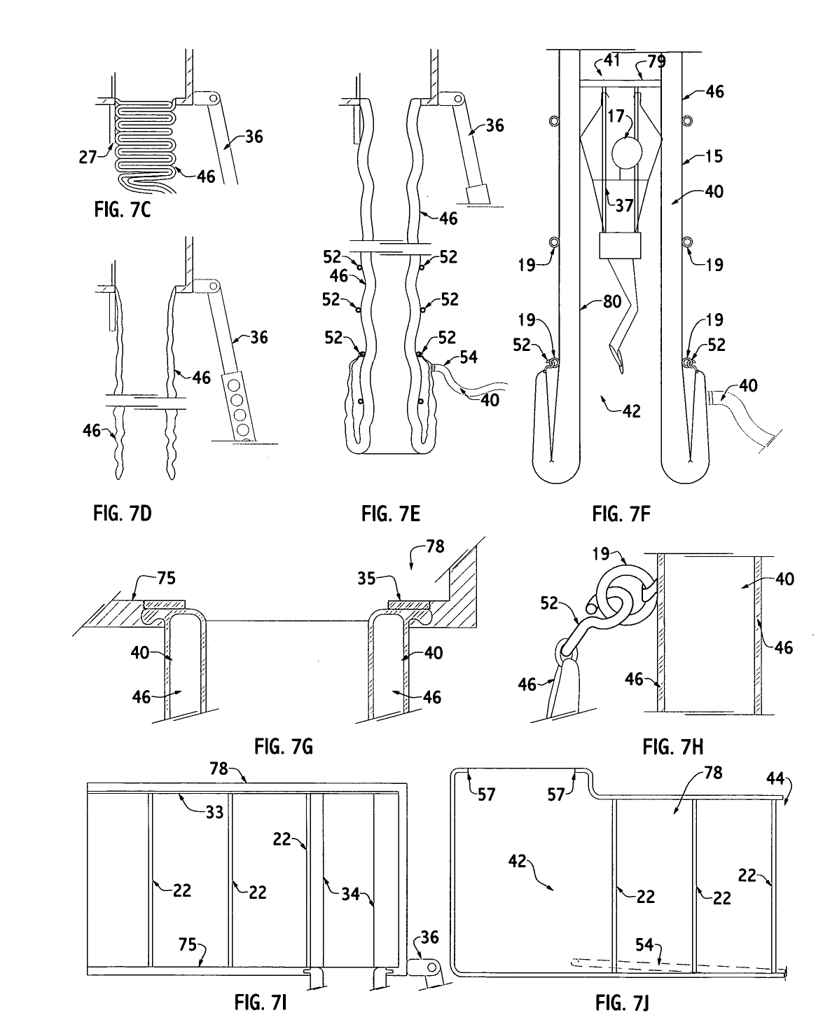

FIG. 7A and FIG. 7B:

FIG. 7A and FIG. 7B show a version of the escape device that may be used by firemen using an extensible boom motor crane 36 that could rise to over one hundred twenty (120) feet high to attend a fire at a building 81 where the extensible boom motor crane 36 would have a upper chamber 78 and sliding doors 22 connected to the extensible boom where in an emergency a fireman 18 would supply harnesses 37 to as many persons 17 as necessary and these persons 17 attached to the “plunger shaped body 79” would open the sliding doors 22 that have a control system that will let only one sliding door 22 open at the same time from where the person 17 would place the “body 79” on the rails 33 and finally go down the guides 34 until the “body 79” is placed inside the tube 80 and this way descend to safety at a controlled speed by use of the difference in pressure between the lesser pressure 41 at the top side of the “body 79” and the higher pressure 42 at the bottom of the “body 79” through the tube 80 which extends from the window it was deployed from, to a height of approximately seven (7) feet above the ground floor 77, and if needed, an additive system would use the bag 44 that with the pressure 40 delivered by the hose 54 inflates and forms the lower chamber 78 and the sliding doors 22 finally leaving the escape device by exit 32.

FIG. 7C:

FIG. 7C shows the bottom end of the upper chamber 78 attached to the extensible boom motor crane 36 where the double walled duct 46 has recently been released when a hatch door 27 is opened.

FIG. 7D:

FIG. 7D shows the bottom end of the upper chamber 78 and the extensible boom motor crane 36 where the double walled duct 46 is fully extended.

FIG. 7E:

FIG. 7E shows the bottom end of the chamber 78 and the top end of the extensible boom motor crane 36 where the double walled duct 46 has been reduced to the proper length according to the height from the floor to the window 73 (FIG. 7A and FIG. 7B) of the building 71 being used as the upper escape level, where a hook 52 is used to hold the double walled duct 46 through a ring 19 at that particular length.

FIG. 7F:

FIG. 7F shows the bottom end of the double walled duct 46 reduced to the proper length according to the height of the window 73 of the building 71 (FIG. 7B) being used as the escape level at the upper floor 75, folding over itself in a way that it still remains being a double walled duct 46, this condition before it is inflated, where the hook 52 is used to hold the lower end of the double walled duct 46 against an upper attachment of the same double walled duct 46 through the ring 19 in position at that particular length, where now air 40 is placed in the interior liner of the double walled duct 46 which is made of a non porous flexible material 15 and which holds the air 40 inside forming a rigid duct or tube 80 therefore the person 17 attached by the harness 37 to the “”body 79” is able to descend due to the lesser pressure 41 being at the top of the “body 79” and the higher pressure 42 at the bottom of the “body 79”.

FIG. 7G:

FIG. 7G shows the bottom end of the upper chamber 78 and the double walled duct 46 where a fixing ring 35 holds the double walled duct 46 against the upper chamber 78.

FIG. 7H:

FIG. 7H shows a section of the double walled duct 46 with the hook 52 joined to the ring 19 holding the excess length of material of the double walled duct 46 to obtain the correct length as selected.

FIG. 7I:

FIG. 7I shows a detail of the upper chamber 78 with the sliding doors 22 and the extensible boom motor crane 36

FIG. 7J:

FIG. 7J shows the bag 44 with the sliding doors 22, which once inflated with the hose 54 that supplies the higher pressure 42, forms the lower chamber 78, and an elastic band 57 that hold itself in place against the double walled duct 46 in case the lower chamber 78 is used.

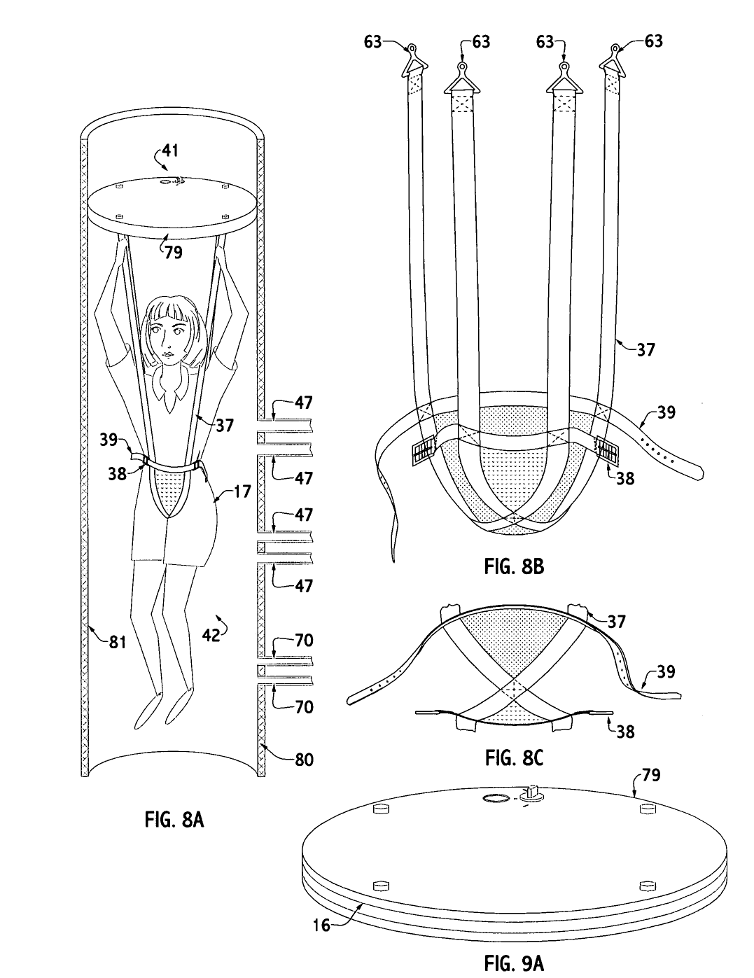

FIG. 8A:

FIG. 8A shows the tube 80 where the “plunger shaped body 79” slides against a smooth surface 81, and where the “body 79” is attached to the harness 37 and to the person 17 using a buckle 38 and a belt 39 and while “the body 79” descends through the tube 80 the “body 79” increases its speed by releasing air through the holes 47 which vary in quantities, sizes and location, and at the end of the descent the body is slowly decelerated by the air released by the smaller holes 70 until finally stopped at the assigned stop floor.

FIG. 8B:

FIG. 8B shows the harness 37 attached to four (4) hooks 63 which is the point of attachment to the “body 79” as shown in FIG. 8A.

FIG. 8C:

FIG. 8C shows a top view of the harness 37 where the buckle 38 and the belt 39 are shown.

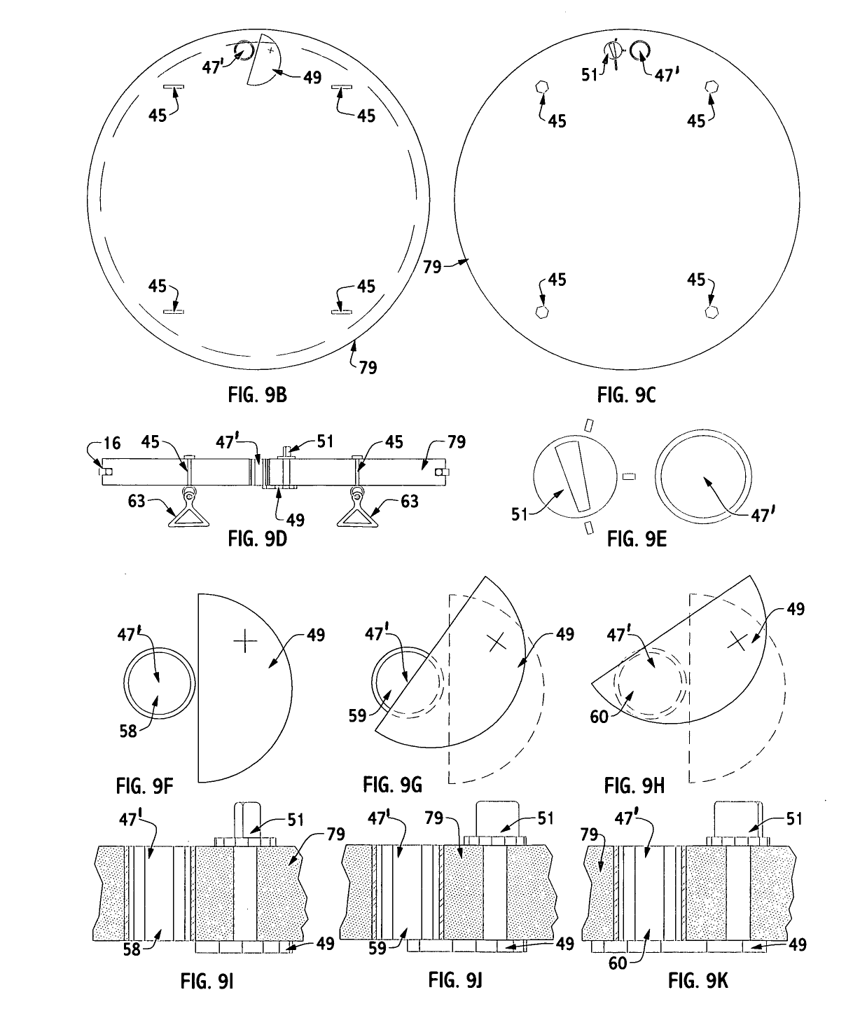

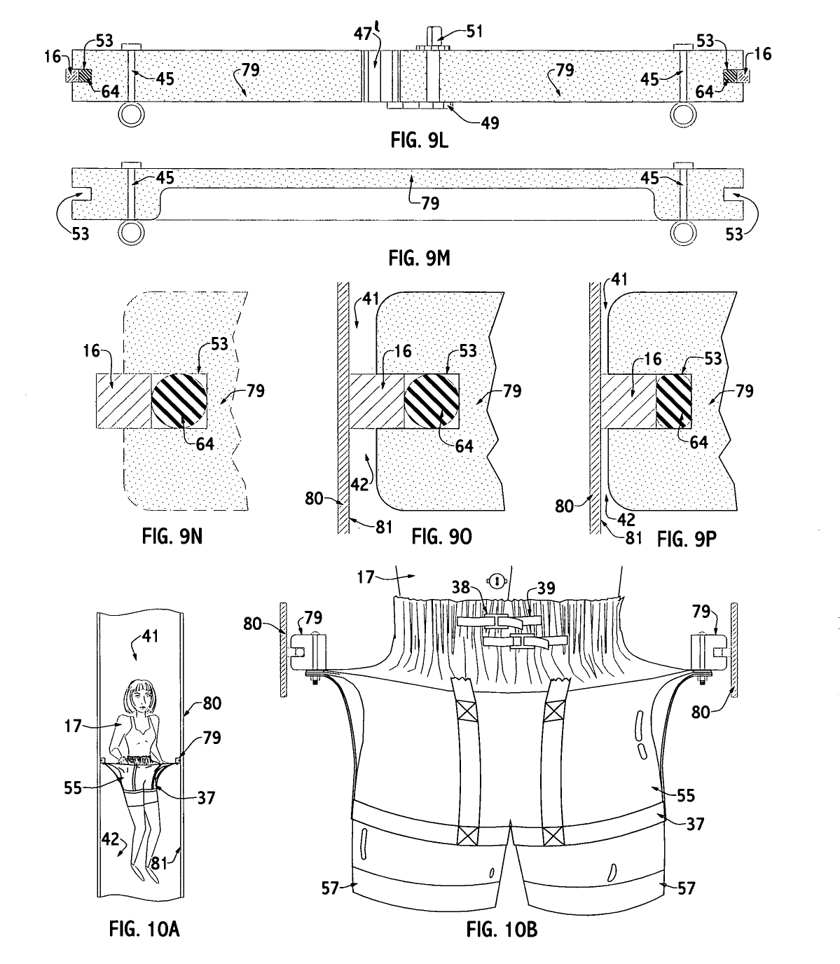

FIG. 9A:

FIG. 9A shows the “plunger shaped body 79” where a frictionless material 16 is used during the descend (See FIG. 8A) through tube 80 to help maintain the lesser pressure 41 and the higher pressure 42 separated.

FIG. 9B:

FIG. 9B shows the top view of the “body 79” where a “hole 47′” and a valve 49 are used to increase or reduce the speed of descend of “the body 79” according to the weight of the person 17. (see FIG. 8A)

FIG. 9C:

FIG. 9C shows the bottom view of the “body 79” where the “hole 47′” and the valve 49 are used to increase or reduce the speed of descend according to the weight of the person 17. (See FIG. 8A)

FIG. 9D:

FIG. 9D shows a cross section of the “body 9” where the “hole 47′” and the valve 49 are used to increase or reduce the speed of descend according to the weight of the person 17. (See FIG. 8A) Also shown are the bolt and nut 45 attached to the belt hook 63 used to hold the harness 37. (See FIG. 8B).

FIG. 9E:

FIG. 9E shows a top view of the “hole 47′” and the valve 49 used to increase or reduce the speed of descend according to the weight of the person 17. (See FIG. 8A)

FIG. 9F:

FIG. 9F shows a bottom view of the “hole 47′” and the valve 49 used to increase or reduce the speed of descend shown on an open 58 position in case the person 17 being evacuated is a lightweight.

FIG. 9G:

FIG. 9G shows a bottom view of the “hole 47′” and the valve 49 used to increase or reduce the speed of descend shown on a half closed 59 position in case the person 17 being evacuated is of average weight.

FIG. 9H:

FIG. 9H shows a bottom view of the “hole 47′” and the valve 49 shown on a closed 60 position in case the person 17 being evacuated is a heavyweight.

FIG. 9I:

FIG. 9I shows a side view of the “hole 47′” and the valve 49 used to increase or reduce the speed of descend of the “body 79” according to their weight and is shown in the open 58 position.

FIG. 9J:

FIG. 9J shows a side view of the “hole 47′” and the valve 49 used to increase or reduce the speed of descend of the “body 79” according to their weight and is shown in the half closed 59 position.

FIG. 9K:

FIG. 9K shows a side view of the “hole 47′” and the valve 49 used to increase or reduce the speed of descend of the “body 79” according to their weight and is shown in the closed 60 position.

FIG. 9L:

FIG. 9L shows a cross sectional view of the “body 79” where a knob 51 moves the valve 49 located on the “hole 47′” and also the frictionless ring 16 with an elastic material 64 that is located in groove 53.

FIG. 9M:

FIG. 9M shows a cross sectional view of the “body 79” where the groove 53 is located.

FIG. 9N:

FIG. 9N shows a cross sectional view of the “body 79” where the frictionless material 16 and the elastic material 64 are placed in the groove 53 in a relaxed position.

FIG. 9O:

FIG. 9O shows a cross sectional view of the “body 79” where the frictionless material 16 and the elastic material 64 are placed in the groove 53 in a relaxed position and are pressed against a smooth surface 81 of the tube 80, where even though there may be a separation between the “body 79” and the tube 80 while sliding, there will be a contact between the frictionless material 16 and the tube 80 maintaining separated the lesser pressure 41 at the top of the “body 79” from the higher pressure 42 at the bottom of the “body 79” and at the same time the elastic material 64 will keep the “body 79” in the center of the tube 80.

FIG. 9P:

FIG. 9P shows a cross sectional view of the “body 79” where the frictionless material 16 and the elastic material 64 are placed in the groove 53 in a compressed position and are pressed against a smooth surface 81 of the tube 80, where even though there may be a separation between the “body 79” and the tube 80 while sliding, there will be a contact between the frictionless material 16 and the tube 80 maintaining separated the lesser pressure 41 at the top of the “body 79” from the higher pressure 42 at the bottom of the “body 79” and at the same time the elastic material 64 will keep the “body 79” in the center of the tube 80.

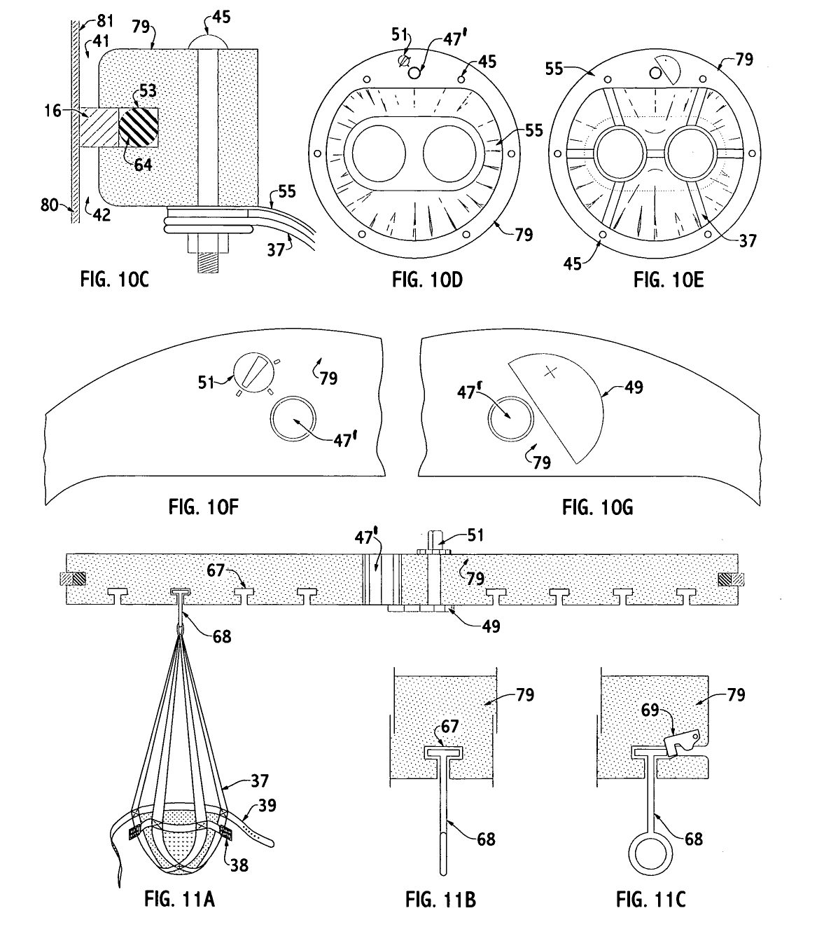

FIG. 10A:

FIG. 10A shows the person 17 attached to the harness 37 and the harness 37 attached to the “ring shaped body 79” that slides against the smooth surface 81 of the tube 80 where the person 17 has a pant 55 attached to the “body 79” and to the harness 37 that maintains the lesser pressure 41 at the top of the “body 79” and the higher pressure 42 at the bottom of the “body 79” thus controlling the descend of the person 17.

FIG. 10B:

FIG. 10B shows the pant 55 attached to the harness 37 and to the “body 79” that slides in the tube 80 attached to the person 17 through a belt 39 and a buckle 38 and said pant 55 has an elastic band 57 that does not let air through the pant 55.

FIG. 10C:

FIG. 10C shows a cross sectional view of the “body 79” where the frictionless material 16 and the elastic material 64 are placed in the groove 53 in a relaxed position and are pressed against a smooth surface 81 of the tube 80, where even though there may be a separation between the “body 79” and the tube 80, there will be a contact between the frictionless material 16 and the tube 80 maintaining separated the lesser pressure 41 at the top of the “body 79” from the greater pressure 42 at the bottom of the “body 79” and at the same time the elastic material 64 will keep the “body 79” in the center of the tube 80.

FIG. 10D:

FIG. 10D shows a top view of the “body 79” showing the “hole 47′” and the knob 51 and the pant 55.

FIG. 10E:

FIG. 10E shows a bottom view of the “body 79” showing the pant 55 and the harness 37.

FIG. 10F:

FIG. 10F shows a top view of a partial area of the “body 79” showing the “hole 47′” and the knob 51.

FIG. 10G:

FIG. 10G shows a bottom view of a partial area of the “body 79” showing the “hole 47′” and the valve 49.

FIG. 11A:

FIG. 11A shows the “plunger shaped body 79” that is used to transport vertically a plurality of persons showing the “hole 47′” and the knob 51 attached to the valve 49 that controls the speed according to the total weight of the persons 17 (See FIG. 2I) and it also shows the harness 37 with the buckle 38 and the belt 39 attached to the “body 79” through the pod clip 68 and the pod slot 67 located at the “body 79”.

FIG. 11B:

FIG. 11B shows the pod clip 68 and the pod slot 67 located at the “body 79”.

FIG. 11C:

FIG. 11C shows the pod clip 68, the pod slot 67 and the clip lock 69 located at the“body 79”

### DRAWING REFERENCE NUMERALS

12. Wall
15. Nonporous flexible material
16. Frictionless material
17. Person or Plurality of persons
18. Fireman, Firefighter
19. Ring
20. Door frame
21. Revolving door
22. Sliding door (s)
24. Two lateral trays
25. Roller bearings
26. Atmospheric pressure
27. Hatch door
28. Locking system
29. Push button
30. Free position
31. Lock position
32. Exit
33. Rail
34. Guides
35. Fixing ring
36. Extensible boom motor crane
37. Harness
38. Buckle
39. Belt
40. Air
41. Lesser pressure
42. Higher pressure
43. Blower
44. Bag
45. Eye bolt & Nut
46. Double wall duct
47. Hole
47′. “Hole in body”, “Hole 47′”
48. Seal
49. Valve
50. Controlled air flow
51. Knob
52. Hook
53. Groove
54. Hose
55. Pant
56. Hinge center
57. Elastic band
58. Open
59. Half closed
60. Closed
61. Flame retardant material
62. Lever
63. Belt hook
64. Elastic material
65. Exit inclined railing
66. Motorized lifting system
67. Pod slot
68. Pod clip
69. Clip lock
70. Small Hole
71. Building
72. Entrance
73. Window
74. Roof floor
75. Upper floor
76. Lower floor
77. Ground floor
78. Chamber
79. Body, “Plunger shaped body”, “Ring shaped body”
80. Tube
81. Smooth surface
101. Door location
102. Door location
103. Door location
201. Door location
202. Door location
203. Door location
301. Door location
302. Door location
303. Door location
401. Door location
402. Door location

403. Door location

| CLAIM | CORRILATED TO |
|---|---|
| NUMBER: | FIGURE NUMBER: |
| 1 | 1A-1C, 2A, 2B, 2E-2I, 8A, 9A |
| 2 | 2I, 8A, 11A |
| 3 | 8A, 9A-9M, 11A |
| 4 | 2F, 2H, 2I, 8A |
| 5 | 2H, 2I, 8A |
| 6 | 2H, 3A-3K, |
| 7 | 5A, 5B |
| 8 | 2I |
| 9 | 2C, 2D |
| 10 | 2J, 8A, 9A |
| 11 | 2J, 8A, 11A |
| 12 | 10F, 10G, 11A |
| 13 | 2J, 8A |
| 14 | 2J |
| 15 | 2J, 3A-3K |
| 16 | 2J |
| 17 | 6A-6E, 7A-7J, 8A, 9A-9P |
| 18 | 6A-6E, 7A-7J |
| 19 | 9A-9P |
| 20 | 3A-3K |
| 21 | 7A, 7J |
| 22 | 3A-3J |
| 23 | 9A-9J |
| 24 | 4A-4J |
| 25 | 9A, 9B, 9L-9P |
| 26 | 9A, 9B, 9L-9P |
| 27 | 2I, 2J, 4A, 7B, 7J |
| 28 | 2A, 2F, 2H-2J, 4A, 4B, 5A, 10A, 10B, 10D, |
| | 10E, 6E, 7A, 7B, 10A, 11A |
| 29 | 2A, 2F, 2H-2J, 4A, 4B, 5A, 10A, 10B, |
| | 10D, 10E, 6E, 7A, 7B, 10A, 11A |
| 30 | 8A-8C |
| 31 | 11A |
| 32 | 8A, 9A-9K, 10F, 10G, 11A |
| 33 | 10A-10G |
| 34 | 10D-10G |
| 35 | 2F, 2H |
| 36 | 8A |
| 37 | 2H, 3A-3K |
| 38 | 2I |
| 39 | 2C, 2D |
| 40 | 9N-9P, 10B, 10C |
| 41 | 9N-9P, 10B, 10C |

I claim:

1. An escape device comprising:
a) a “plunger shaped body” attached to a person with a harness
b) that slides through a vertical tube
c) that by means of a differential pressure at the top and bottom of said tube slows the rate of descend of said “plunger shaped body”,
whereby allowing a controlled evacuation of the persons from a multistory building.

2. An escape device comprising:
a) a “plunger shaped body” to which a plurality of persons are attached each with a harness
b) that slides through a vertical tube
c) that by means of a differential pressure at the top and bottom of said tube slows the rate of descend of said “plunger shaped body”,
whereby allowing a controlled evacuation of the persons from a multistory building.

3. The escape device in claim 1 and in claim 2 wherein said “plunger shaped body” by means of a hole from the top to the bottom of said “plunger shaped body”, and by means of a valve that controls the amount of air flow to vary the speed of fall of said “plunger shaped body” through the tube therefore controlling the descend of the persons according to their particular weight, whereby allowing a controlled evacuation of the persons from a multistory building.

4. The escape device in claim 1, and in claim 2 wherein said vertical tube by means of a pattern of holes or valves of different sizes, quantities and at specific locations, placed along said tube from the inside to the outside of said tube in a way that the “plunger shaped body” would have the optimum acceleration and speed going downward to decrease the time of evacuation of the persons, whereby allowing a controlled evacuation of the persons from a multistory building.

5. The escape device in claim 1, and in claim 2 wherein said vertical tube by means of a pattern of holes or valves of different sizes, quantities and in specific locations, placed at the lower end of said tube in a way that these holes or valves would safely decelerate the speed of the “plunger shaped body” while going downward to bring said “plunger shaped body” to a complete stop on the descend of the person whereby allowing a controlled evacuation of the persons from a multistory building.

6. The escape device in claim 1, in claim 2, in claim 3, in claim 4, and in claim 5 wherein the entrance and exit of said tube by means of a sequence of doors that are composed of at least 2 doors on each end of the tube where the doors would be controlled by means of a mechanical system that permits that only one door can be opened at a given time to hold the lesser pressure above the “plunger shaped body” and the higher pressure below the “plunger shaped body” to assure the safe descend of the persons whereby allowing a controlled evacuation of the persons from a multistory building.

7. The escape device in claim 1, in claim 2, in claim 3, in claim 4, and in claim 5 wherein the entrance and exit of said tube by means of a hatch door at each end of the tube where the hatch doors would be controlled by means of a mechanical system that permits that only one hatch door can be opened at a given time to hold the lesser pressure above the “plunger shaped body” and the higher pressure below the “plunger shaped body” to assure the safe descend of the person whereby allowing the evacuation of the person from a high structure or building.

8. The escape device in claim 1, in claim 2, in claim 3, in claim 4, in claim 5 and in claim 6 wherein by means of an exterior blower or by artificial means of a variance of the lesser pressure at the top of the “plunger shaped body” and the variance of the higher pressure at the bottom of the “plunger shaped body” to control the descend of the persons whereby allowing a controlled evacuation of the persons from a multistory building.

9. The escape device in claim 1, in claim 2, in claim 3, in claim 4, in claim 5, in claim 6 and in claim 8 wherein by means of an inclined lateral tray roller bearing system at the lower end of the tube that would receive the “plunger shaped body” and remove the “plunger shaped body” laterally out of the path of the next “plunger shaped body” being lowered as to increase the amount of persons being evacuated through the escape tube at a given time whereby allowing a controlled evacuation of the persons from a multistory building.

10. A lifting device comprising:
a) a “plunger shaped body” attached to a person through a harness
b) that slides through a vertical tube
c) that by means of an artificial pressure or a blower connected at the bottom of the tube where the higher pressure below the “plunger shaped body” sends said “plunger shaped body” through said tube from the lower floors to the higher floors of a building at high speeds,
whereby allowing rescue men or firemen to ascend to the upper floors of the building to rescue people without interfering with the evacuation of persons going down through the stairways of a multistory building.

11. A lifting device comprising:
a) a “plunger shaped body” attached to a plurality of persons each with a harness
b) that slides through a vertical tube
c) that by artificial means or by means of a blower connected at the bottom of the tube where the higher pressure below the “plunger shaped body” sends said “plunger shaped body” through said tube from the lower floors to the higher floors of a building at high speeds,
whereby allowing rescue men or firemen to ascend to the upper floors of the building to rescue people without interfering with the evacuation of persons going down through the stairways of a multistory building.

12. The lifting device in claim 10 and in claim 11 wherein said “plunger shaped body” by means of a hole from the top to the bottom of said “plunger shaped body”, said hole containing a valve that controls the amount of air flow to vary the speed of rise of said “plunger shaped body” through said tube therefore controlling the lift of each fireman according to the sum of their weight, whereby allowing rescue men or firemen to ascend to the upper floors of the building without interference of the evacuees.

13. The lifting device in claim 10, in claim 11, and in claim 12 wherein said vertical tube by means of a pattern of holes or valves of different sizes, quantities and in specific locations, placed along said tube from the inside to the outside of said tube in a way that the “plunger shaped body” would have the optimum acceleration and speed going upward to decrease the time of lift of the firefighters whereby allowing the rescue men or firemen to ascend to help the evacuees trapped in the building.

14. The lifting device in claim 10, in claim 11, in claim 12 and in claim 13 wherein said vertical tube by means of a pattern of holes or valves of different sizes, quantities and in specific locations at the upper end of the tube from the inside to the outside of said tube in a way that the “plunger shaped body” will have the optimum decelerating conditions when slowing to a controlled stop the lift of each fireman whereby allowing firemen to rescue the evacuees that are stranded and trapped in the building.

15. The lifting device in claim 10, in claim 11, in claim 12, in claim 13 and in claim 14 wherein the entrance and exit of said tube by means of a sequence of doors that are composed of at least 2 doors on each end where the doors are controlled by means of a mechanical system that permits that only one door at each end can be opened at a given time to hold the lesser pressure and the higher pressure to assure the safe ascend of each fireman being lifted to the upper floors whereby allowing rescue men or firemen to ascend through the building without interference of the evacuees.

16. The lifting device in claim 10, in claim 11, in claim 12, in claim 13, in claim 14 and in claim 15 wherein by means of a vertical lift conveyor and by means of an inclined lateral tray roller bearing system at the upper end of the tube, the “plunger shaped body” would move out of the way giving way to other “plunger shaped bodies” with as many rescue men that ascends through the lift tube to rescue the stranded or injured persons whereby allowing a controlled evacuation of the persons from a multistory building.

17. An escape device comprising of
a) a “plunger shaped body” attached to a person with a harness
b) that slides through an air inflated double walled duct that acts as a tube,
c) that by means of a differential pressure at the top and bottom of said tube slows the descend of said “plunger shaped body”,
whereby allowing a controlled evacuation of the persons from a multistory building.

18. The escape device in claim 17, and by the means of the inflatable double walled duct kept in storage at an upper floor which is released from its storage area when in an emergency conforming a tube by means of compressed air and said tube being used as an escape device whereby allowing a controlled evacuation of the persons from a multistory building.

19. The escape device in claim 17 and claim 18 wherein said “plunger shaped body” by means of a hole from the top to the bottom of said “plunger shaped body”, and by means of a valve that controls the amount of air flow to vary the speed of fall of said “plunger shaped body” through the tube therefore controlling the descend of the persons according to their particular weight, whereby allowing a controlled evacuation of the persons from a multistory building.

20. The escape device in claim 17, in claim 18 and in claim 19, by means of a sequence of doors with of at least 2 doors at the top end of the tube by means of a mechanical system that permits that only one door can be opened at a given time to hold the lesser pressure to assure the safe descend of the persons being rescued whereby allowing a controlled evacuation of the persons from a multistory building.

21. The escape device in claim 17, and by fixing the top end of the double walled duct to an extensible boom crane and the other lower end after having it reduced to a predetermined shorter length by means of folding over itself the double walled duct material in a way that it still remains being a duct, this before it is inflated so that when inflated it obtains the form of a tube and where the “plunger shaped body” is lowered through the tube at a controlled speed whereby allowing a controlled evacuation of the persons from a multistory building.

22. The escape device in claim 17, in claim 21 wherein the entrance and exit of said tube by means of a sequence of doors that are composed of at least 2 doors on each end of the tube where the doors would be controlled by means of a mechanical system that permits that only one door can be opened at a given time to hold the lesser pressure above the “plunger shaped body” and the higher pressure below the “plunger shaped body” to assure the safe descend of the persons whereby allowing a controlled evacuation of the persons from a multistory building.

23. The escape device in claim 17, in claim 21 and in claim 22, wherein the “plunger shaped body” by means of a hole that crosses from the top to the bottom of said “plunger shaped body”, and by means of a valve that controls the amount of air flow to vary the speed of fall of said “plunger shaped body” through the tube therefore controlling the descend of the persons according to their particular weight whereby allowing a controlled evacuation of the persons from a multistory building.

24. The escape device in claim 1, in claim 2, in claim 3, in claim 4, and in claim 5 wherein by means of revolving doors on each end of the tube where the revolving doors have the characteristic that the air pressure alone will not make them rotate, these revolving doors which hold the lesser pressure above the “plunger shaped body” and the higher pressure below the “plunger shaped body” to assure the safe descend of the persons whereby allowing a controlled evacuation of the persons from a multistory building.

25. The escape device in claim 1, in claim 2 and in 3, the lifting device in claim 10, in claim 11 and in claim 12, and the escape device in claim 17 and in claim 19 where by means of the outer edge of said “plunger shaped body” there is a groove where an elastic material is placed in the inner position of said groove and a frictionless material is placed at the outer position of said groove in a way that both the frictionless material and the elastic material are in the same groove where when the “plunger shaped body” is moving along the tube and the smooth surface of the tube is in contact with the frictionless material placed in the groove, the elastic material absorbs the stress and the movement when it is pushed into the groove by the frictionless material moving against the smooth surface of the tube.

26. The escape device in claim 1, in claim 2 and in claim 3, the lifting device in claim 10, in claim 11 and in claim 12, and the escape device in claim 17, in claim 19 and in claim 25, where by means of the seal created between the frictionless material and the elastic material at the outside edge of the “plunger shaped body” and by means of the seal created between the frictionless material at the “plunger shaped body” and the smooth surface of the tube, the differential pressure between the bottom side and top side of the “plunger shaped body” is kept as high as needed while the device is used.

27. The escape device in 17, in claim 21, in claim 22, in claim 23, in claim 25 and in claim 26 wherein by means of a blower or by means of an exterior source a lesser pressure at the top of the “plunger shaped body” and a higher pressure at the bottom of the “plunger shaped body” is maintained to control the descend of the persons whereby allowing a controlled evacuation of the persons from a multistory building.

28. The escape devices in claim 1 through claim 9, in claim 17 through claim 27, and the rescue device in claim 10 through claim 16, where by means of using these inventions in any relation to amusement parks of any kind.

29. The escape devices in claim 1 through claim 9, in claim 17 through claim 28, and the rescue device in claim 10 through claim 16, where by means of using these inventions in any relation to training of personnel of any kind.

30. The escape device in claim 1 through claim 9, in claim 17 through claim 29, and the rescue device in claim 10 through claim 16, where by means of a four (4) point harness system attached to the “plunger shaped body” is used to evacuate people from the building in distress.

31. The escape device in claim 1 through claim 9, in claim 17 to claim 29 and the rescue device in claim 10 through claim 16, where by means of a four (4) point harness attached to a central pod clip.

32. The escape device in claim 2 in claim 11 and in claim 31, and by means of a “plunger shaped body” to which a plurality of persons are attached each with a harness whereby allowing a controlled evacuation of the persons from a multistory building.

33. An escape device comprising:
a) a “ring shaped body” attached to a person with a sealed pant harness
b) that slides through a vertical tube
c) that by means of a differential pressure at the top and bottom of said tube slows the rate of descend of said “ring shaped body”,
whereby allowing a controlled evacuation of the persons from a multistory building.

34. The escape device in claim 33, wherein said “ring shaped body” by means of a hole from the top to the bottom of said “ring shaped body”, and by means of a valve that controls the amount of air flow to vary the speed of fall of said “ring shaped body” through the tube therefore controlling the descend of the persons according to their particular weight, whereby allowing a controlled evacuation of the persons from a multistory building.

35. The escape device in claim 33, wherein said vertical tube by means of a pattern of holes or valves of different sizes, quantities and at specific locations, placed along said tube from the inside to the outside of said tube in a way that the “plunger shaped body” would have the optimum acceleration and speed going downward to decrease the time of evacuation of the persons, whereby allowing a controlled evacuation of the persons from a multistory building.

36. The escape device in claim 33, wherein said vertical tube by means of a pattern of holes or valves of different sizes, quantities and in specific locations, placed at the lower end of said tube in a way that these holes or valves would safely decelerate the speed of the “ring shaped body” while going downward to bring said “plunger shaped body” to a complete stop on the descend of the person whereby allowing a controlled evacuation of the persons from a multistory building.

37. The escape device in claim 33, in claim 34, in claim 35 and in claim 36, wherein the entrance and exit of said tube by means of a sequence of doors that are composed of at least 2 doors on each end of the tube where the doors would be controlled by means of a mechanical system that permits that only one door can be opened at a given time to hold the lesser pressure above the “ring shaped body” and the higher pressure below the “ring shaped body” to assure the safe descend of the persons whereby allowing a controlled evacuation of the persons from a multistory building.

38. The escape device in claim 33, in claim 34, in claim 35, in claim 36 and in claim 37, wherein by means of an exterior blower or by artificial means of a variance of the lesser pressure at the top of the “ring shaped body” and the variance of the higher pressure at the bottom of the “ring shaped body” to control the descend of the persons whereby allowing a controlled evacuation of the persons from a multistory building.

39. The escape device in claim 33, in claim 34, in claim 35, in claim 36, in claim 37 and in claim 38, wherein by means of an inclined lateral tray roller system at the lower end of the tube, placed at a height from the lower end of the tube where the “ring shaped body” would clear in height when moving away from the tube in order to let other “ring shaped bodies” descend as to increase the amount of persons being evacuated through the escape tube at a given time whereby allowing a controlled evacuation of the persons from a multistory building.

40. The escape device 33 and in claim 34, where by means of the outer edge of said “ring shaped body” there is a groove where an elastic material is placed in the inner position of said groove and a frictionless material is placed at the outer position of said groove in a way that both the frictionless material and the elastic material are in the same groove where when the “ring shaped body” is moving along the tube and the smooth surface of the tube is in contact with the frictionless material placed in the groove, the elastic material absorbs the stress and the movement when it is pushed into the groove by the frictionless material moving against the smooth surface of the tube.

41. The escape device in claim 33, in claim 34 and in claim 40, where by means of the seal created between the frictionless material and the elastic material at the outside edge of the “ring shaped body” and by means of the seal created between the frictionless material at the “ring shaped body” and the smooth surface of the tube, the differential pressure between the bottom side and top side of the “plunger shaped body” as high as needed while the device is used.
